(19) United States
(12) Patent Application Publication
(10) Pub. No.: US 2025/0153309 A1
(43) Pub. Date: May 15, 2025

(54) SIGNAL PROCESSING FOR FINDING SUBSTRATE NOTCH

(71) Applicant: Applied Materials, Inc., Santa Clara, CA (US)

(72) Inventors: Nojan Motamedi, Sunnyvale, CA (US); Dominic J. Benvegnu, La Honda, CA (US); Harry Q. Lee, Los Altos, CA (US); Boguslaw A. Swedek, Morgan Hill, CA (US)

(21) Appl. No.: 18/939,322

(22) Filed: Nov. 6, 2024

Related U.S. Application Data
(60) Provisional application No. 63/599,345, filed on Nov. 15, 2023.

(51) Int. Cl. B24B 49/12; H02P 29/00

(52) U.S. Cl. CPC B24B 49/12; H02P 29/0016

(57) ABSTRACT

A notch finding apparatus includes a sensor to generate a signal that depends on an proportion of a sensing region of the sensor that is covered by a substrate, and a controller configured to cause an actuator to position a carrier head relative to the substrate with the sensing region of the sensor at an edge of the substrate, cause a motor to generate relative motion between the carrier head and the sensor such that the sensing region of the sensor scans along a circumference of the substrate, and detect an angular position of a notch in the edge of the substrate based on an initial signal from the sensor, including generating a second or higher order derivative signal from the initial signal.

### CROSS-REFERENCE TO RELATED APPLICATIONS

This application claims the benefit of priority to U.S. Application No. 63/599,345, filed on Nov. 15, 2023, the contents of which are hereby incorporated by reference.

### TECHNICAL FIELD

This disclosure relates to detecting the angular position of a substate, such as the position of a substrate notch, e.g., in a chemical mechanical polishing (CMP) system.

### BACKGROUND

An integrated circuit is typically formed on a substrate by the sequential deposition of conductive, semiconductive, or insulative layers on a silicon wafer. One fabrication step involves depositing a filler layer over a non-planar surface and planarizing the filler layer. For certain applications, the filler layer is planarized until the top surface of a patterned layer is exposed. A conductive filler layer, for example, can be deposited on a patterned insulative layer to fill the trenches or holes in the insulative layer. After planarization, the portions of the metallic layer remaining between the raised pattern of the insulative layer form vias, plugs, and lines that provide conductive paths between thin film circuits on the substrate. For other applications, such as oxide polishing, the filler layer is planarized until a predetermined thickness is left over the non-planar surface. In addition, planarization of the substrate surface is usually required for photolithography.

Chemical mechanical polishing (CMP) is one accepted method of planarization. This planarization method typically requires that the substrate be mounted on a carrier or polishing head. The exposed surface of the substrate is typically placed against a rotating polishing pad. The carrier head provides a controllable load on the substrate to push it against the polishing pad. An abrasive polishing slurry is typically supplied to the surface of the polishing pad.

### SUMMARY

In one aspect, a notch finding apparatus includes a sensor to generate a signal that depends on an proportion of a sensing region of the sensor that is covered by a substrate, and a controller configured to cause an actuator to position a carrier head relative to the substrate with the sensing region of the sensor at an edge of the substrate, cause a motor to generate relative motion between the carrier head and the sensor such that the sensing region of the sensor scans along a circumference of the substrate, and detect an angular position of a notch in the edge of the substrate based on an initial signal from the sensor, including generating a second or higher order derivative signal from the initial signal.

In another aspect, a notch finding apparatus includes a sensor to generate a signal that depends on an proportion of a sensing region of the sensor that is covered by a substrate, and a controller is configured to cause an actuator to position a carrier head relative to the substrate with the sensing region of the sensor at an edge of the substrate, cause a motor to generate relative motion between the carrier head and the sensor such that the sensing region of the sensor scans along a circumference of the substrate, and detect an angular position of a notch in the edge of the substrate based on an initial signal from the sensor, including generating a first or higher order derivative signal from the initial signal and determining an angular position at which the first or higher order derivative signal has a maximum peak or a minimum valley.

Implementations may include one or more of the following potential advantages. The angular position of a substrate relative to the carrier head can be determined even for a noisy signal, e.g., from a patterned substrate. The carrier head can rotate to place the substrate notch in a desired angular position. Polishing can be performed more consistently on a wafer-to-wafer basis, thus reducing wafer-to-wafer non-uniformity (WTWNU). In-situ monitoring can be more reliable, thus improving both within-wafer uniformity (WIWU) and wafer-to-wafer uniformity (WTWU).

The details of one or more implementations are set forth in the accompanying drawings and the description below. Other aspects, features and advantages will be apparent from the description and drawings, and from the claims.

### DESCRIPTION OF DRAWINGS

FIG. 1 is a schematic plan view of an example of a polishing apparatus.

FIG. 2 is a schematic cross-sectional view of an example of a polishing apparatus.

FIG. 3 is a schematic side view of an example of an inter-platen notch finder.

FIGS. 4A and 4B are schematic top views of substrates with different notches.

FIG. 5 is a schematic bottom view of a substrate and a retaining ring showing a path of a scanning spot along a circumference of the substrate.

FIG. 6 is an illustrative graph of intensity of reflected light as a function of the angular orientation of the carrier head.

FIG. 6A is an illustrative graph of intensity of reflected light as a function of the angular orientation of the carrier head for a patterned substrate.

FIG. 6B is an illustrative graph of a second derivative of an intensity of reflected light as a function of the angular position of the carrier head for a patterned substrate.

FIG. 7 is a schematic side view of another example of an inter-platen notch finder that includes two light sources.

FIG. 8 is a schematic side view of another example of an inter-platen notch finder that includes a camera.

FIG. 9 is a schematic side view of another example of an inter-platen notch finder that directs a light beam through a water column.

FIG. 10 is a schematic side view of another example of an inter-platen notch finder that submerges a face of the substrate in a liquid bath.

Like reference symbols in the various drawings indicate like elements.

### DETAILED DESCRIPTION

In some polishing operations the substrate is held by a rotating carrier head and pressed against the rotating polishing pad. Rotation of the carrier head imparts rotation to the substrate.

It would be desirable to align each substrate to a consistent angular orientation before chemical mechanical polishing, as this can result in more reproducible polishing and in-situ measuring of film thickness, especially for patterned wafers. Without being limited to any particular theory, a consistent angular orientation improves the likelihood that a sensor scans each substrate on a repeatable path, so that the resulting signal is consistently positioned on the same portion of the substrate as a function of time on a wafer-to-wafer basis. This in turn improves reliability of a pressure control algorithm, which can improve both within-wafer uniformity (WIWU) and wafer-to-wafer uniformity.

Hypothetically, a carrier head could simply rotate to a preset angular orientation before polishing commences, e.g., before the substrate is lowered into contact with the polishing pad. However, the angular orientation of the substrate relative to the carrier head may not stay constant; the substrate can be subject to a “precession” effect in which the substrate rotates relative to the carrier head. Thus, simply relying on the carrier head orientation, e.g.,. as measured by a motor encoder, may not be sufficient.

A technique to address this problem is to measure the angular orientation of the substrate before a polishing operation or between two separate polishing operations, e.g., at a station positioned between two platens of the polishing system. For example, a light beam can be directed at the edge of the substrate, a detector can measure an intensity of the reflected light, and the carrier head can rotate. When the notch passes through the illuminated spot, the amount of reflected light should change, e.g., drop.

A further issue is that when the substrate is “chucked” to the carrier head for transfer between platens, the center of the substrate may not be precisely aligned with the axis of rotation of the carrier head. As a result, merely rotating the carrier head to scan a sensor around the circumference of the substrate may not work. For example, the sensor may move outside the radius of the substrate, resulting in a loss of signal. Moreover, the signal from the sensor can be subject to variation simply from scanning across different radial positions on the substate, and this variation can exceed the effect of the notch on the signal, thus masking the position of the notch.

A technique to address this problem is to detect and filter out a sinusoidal variation in the signal from the sensor, and then to detect a variation in the signal, e.g., a drop in signal strength, that indicates the presence of the notch.

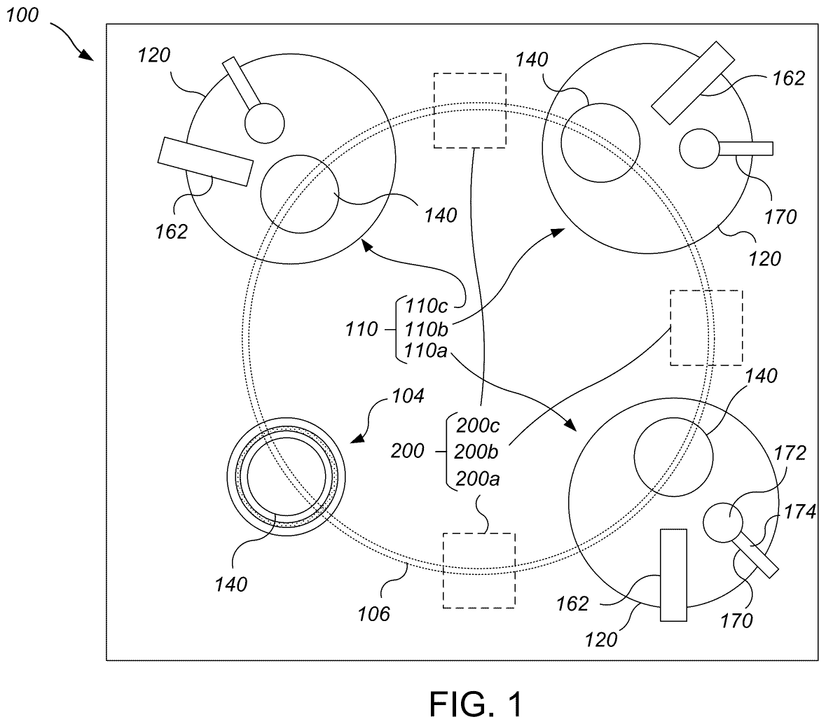

FIG. 1 is a plan view of a chemical mechanical polishing apparatus 100 for processing one or more substrates. The polishing apparatus 100 includes a plurality of polishing stations 110. For example, the polishing apparatus can include three polishing stations 110a, 110b, and 110c. The polishing apparatus 100 also includes at least one carrier head 140, e.g., four carrier heads 140. The polishing apparatus 100 also includes a transfer station 104 for loading and unloading substrates from the carrier heads 140. The stations of the polishing apparatus 100, including the transfer station 104 and the polishing stations 110, can be positioned at substantially equal angular intervals around the center of the platform 106.

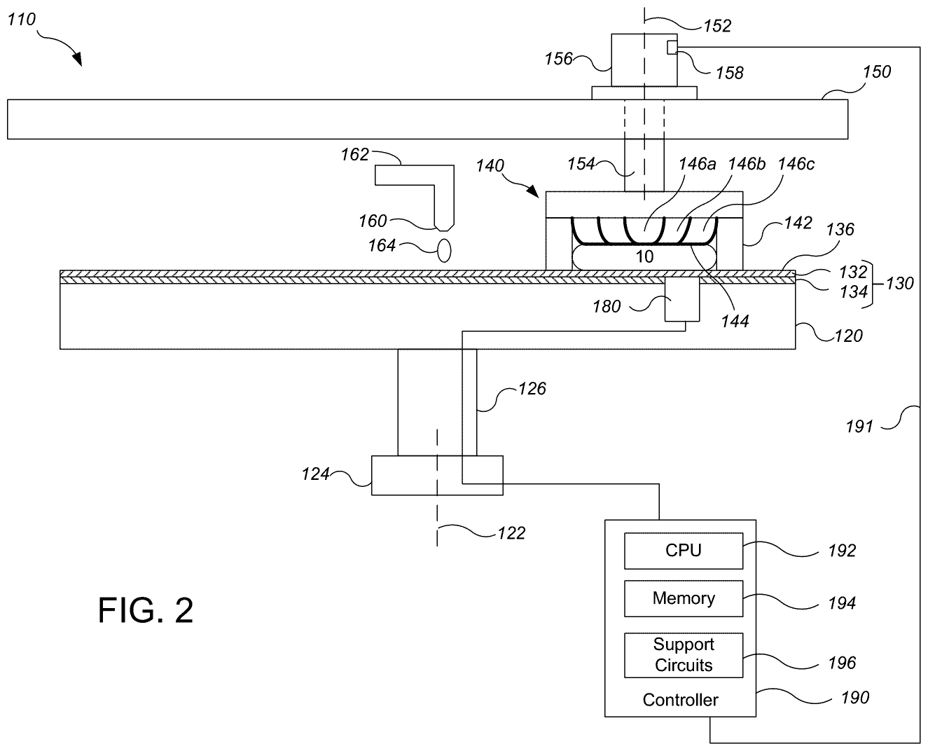

Referring to FIG. 2, each polishing station 110 includes a polishing pad 130 supported on a rotatable platen 120. The polishing pad 130 can be a two-layer polishing pad with an outer polishing layer 132 and a softer backing layer 134 (see FIG. 2). A top surface of the polishing layer 132 can provide a polishing surface 136.

Returning to FIG. 1, for a polishing operation, one carrier head 140 is positioned at each polishing station 110. Another additional carrier head 140 can be positioned in the transfer station 122 to exchange a polished substrate for an unpolished substrate while the other substrates are being polished at the polishing stations 110.

The carrier heads 140 are held by a support structure, e.g., a rotatable carousel or a carriage suspended from a track, that can cause carrier head to move along a 106 path that passes, in order, each polishing station 110a-110c and the transfer station 104.

Referring to FIGS. 1 and 2, each polishing station 110 can include a port 160, e.g., at the end of an arm 162, to dispense polishing liquid 164, such as abrasive slurry, onto the polishing pad 130. Each polishing station 110 of the polishing apparatus 100 can also include pad conditioning apparatus 170 to abrade the polishing pad 130 to maintain the polishing surface 136 in a consistent abrasive state. For example, the conditioning apparatus can include a conditioning head 172 with a conditioning disk at the end of an arm 174.

As shown in FIG. 2, the platen 120 at each platen 120 is operable to rotate about an axis 122. For example, a motor 124 can turn a drive shaft 126 to rotate the platen 120. Each carrier head 140 is operable to hold a substrate 10 against the polishing pad 130. Each carrier head 140 can include a retaining ring 142 to retain the substrate 10 below a flexible membrane 144. Each carrier head 140 can also include a plurality of independently controllable pressurizable chambers defined by the membrane, e.g., three chambers 146a-146c, which can apply independently controllable pressurizes to associated zones on the flexible membrane 144 and thus on the substrate 10. Although only three chambers are illustrated in FIG. 2 for ease of illustration, there could be one or two chambers, or four or more chambers, e.g., five chambers.

Each carrier head 140 is suspended from the support structure 150, and is connected by a drive shaft 154 to a carrier head rotation motor 156 so that the carrier head can rotate about an axis 152. Optionally each carrier head 126 can oscillate laterally, e.g., driven by a carriage on the track, by a motor that oscillates the carrier head radially, or by rotational oscillation of the carousel itself.

In operation, the platen is rotated about its central axis 121, and each carrier head is rotated about its central axis 127 and translated laterally across the top surface of the polishing pad.

An in-situ monitoring system can include a sensor 180 installed in the platen 120 to monitor the progress of the polishing operation and/or measure a thickness of the layer on the substrate 10 that is being polished. The sensor 180 could be an optical sensor, e.g., a spectrometer, an eddy current sensor, a capacitive sensor, a friction sensor, etc.

A controller 190, such as a programmable computer, is connected to each motor 126, 156 to independently control the rotation rate of the platen 120 and the carrier heads 140. For example, each motor 156 can include an encoder 158 that measures the angular position or rotation rate of the associated drive shaft 154. The associated drive shafts can have respective reference angular positions that are recognized by the encoder 158 to measure the number of revolutions of the drive shafts.

The controller 190 is also connected to pressure regulators to control the pressures in the chambers 146a-146c. In particular, the controller 190 can be configured to receive thickness measurements from the in-situ monitoring system and control the pressures in the chambers 146a-146c to provide improved polishing uniformity.

The controller 190 can include a central processing unit (CPU) 192, a memory 194, and support circuits 196, e.g., input/output circuitry, power supplies, clock circuits, cache, and the like. The memory is connected to the CPU 192. The memory is a non-transitory computable readable medium, and can be one or more readily available memory such as random access memory (RAM), read only memory (ROM), floppy disk, hard disk, or other form of digital storage. In addition, although illustrated as a single computer, the controller 190 could be a distributed system, e.g., including multiple independently operating processors and memories.

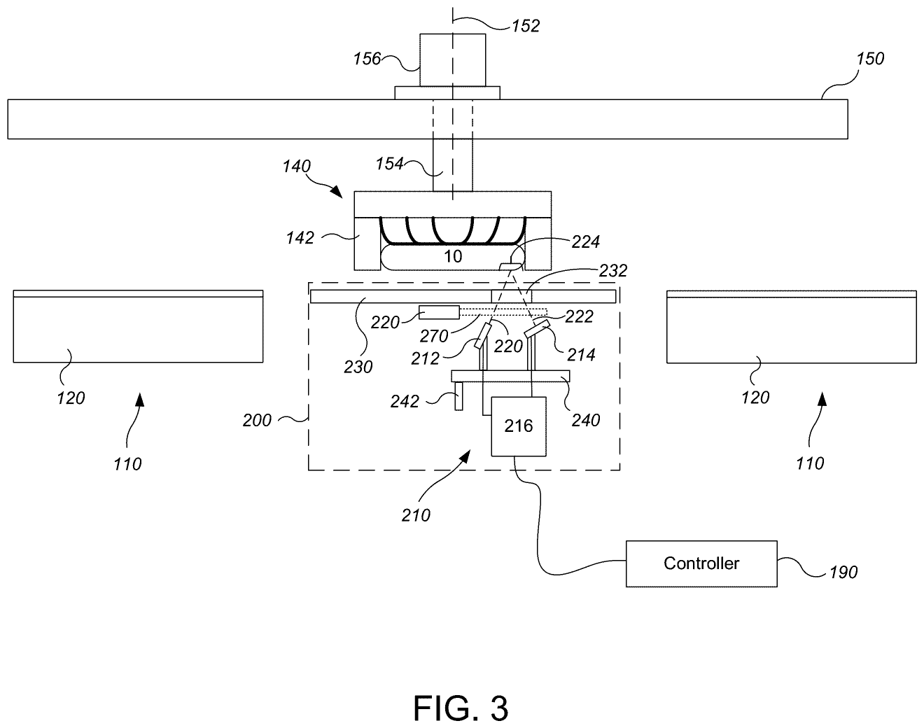

Referring to FIGS. 1, and 3, the polishing apparatus 100 can also include one or more notch-finding stations 200. In some implementations, a notch-finding station 200a is positioned on the path 106 at a spot between the transfer station 104 and a first polishing station, e.g., polishing station 110a. One or more notch-finding stations 200b, 200c can be positioned on the path 106 travelled by the carrier heads 140 between two polishing stations 200.

In some implementations, the polishing system includes two inter-platen notch-finding stations 200b, 200c. The two inter-platen notch-finding stations 200b, 200c could be on the path 106 on opposite sides of a polishing station, e.g., the second polishing station 110b.

In some modes of operation, the substrate orientation is measured at a notch-finding station 200 located before a polishing station 110 along the path 106, and then moved forward along the path 106 to the polishing station 110 and polished at that polishing station 110. However, in some modes of operation, the substrate orientation can be measured at a notch-finding station 200 located after a polishing station 110 along the path 106, and then moved backward along the path 106 to the polishing station 110 and polished at that polishing station 110. The substrate can then be moved forward again along the path 106 to the next polishing station, optionally stopping at the notch-finding station 200 before being polished at the next polishing station.

FIG. 3 illustrates an implementation of a notch finding station 200 positioned between two platens 120 of two polishing stations 110 that are adjacent along the path. This implementation of the notch finding station 200 has an optical notch detector 210 that includes a light source 212, a light detector 214, and circuitry 216 for sending and receiving signals between the controller 190 and the light source 212 and light detector 214. The optical notch detector 210 can also be considered to include some of the functionality implemented, e.g., software, in the controller 190.

The light source 212 is located such that a carrier head 140 can be positioned on the path 106 where the substrate 100 can scanned by the optical notch detector 210. In particular, the light source 212 generates a light beam 220 that can be reflected by the substrate 10, and the light detector 214 is positioned to receive a reflected light beam 222 from the substrate 10. The light detector 214 can be positioned where the light beam 220 and reflected light beam 22 have equal incidence angles, e.g., such that the light detector 214 is receiving reflected (rather than scattered) light. The angle of incidence on the substrate 10 can be normal to the substrate surface, or an oblique angle up to 80°,.e.g., 30° or 45°. Although FIG. 2 illustrates the light beam 220 travelling in a straight line to the substate 10, one or more mirrors can be positioned in the optical path of the light beam 220.

The light source 212 can generate substantially monochromatic light and/or collimated light. For example, the light source 212 can be a laser, e.g. in the visible wavelength range of 400-700 nm, as this can make alignment of the sensor easier.

However, wavelengths in infrared range or ultraviolet range can be used. Alternatively, the light source 212 can be operable to emit white light. For example, the light source 212 can be is a xenon lamp or a xenon mercury lamp. The light detector 164 can be a photodetector, e.g., a detector that outputs a simple scalar signal indicating total light intensity. Alternatively, the light detector 164 can output multiple signals, each for a different wavelength range.

Optionally, one or more optical fibers can be used to transmit the light from the light source 212 to a position below the substrate, and/or transmit light reflected from the substrate 10 to the detector 214. For example, a bifurcated optical fiber can be used to transmit the light from the light source 212 to the substrate 10 and back to the detector 214.

The notch finding station 200 can include a mechanism to adjust the vertical height of the optical component from which the light beam passes directly to the substrate 10. For example, the optical components, including mirrors if present, can be supported on an optical plate or frame 240. An actuator 242 can adjust the vertical position of the optical plate or frame 240. In some implementations, the actuator 242 can also include an XY actuator system that includes two independent linear actuators to move the optical plate or frame 240 independently along two orthogonal axes. If an optical fiber is used, then the actuator 242 can adjust a position of an end of the fiber.

In some implementations, a shield 230 can be positioned between the carrier head 140 and the optical components of the optical notch detector 210, e.g., the light source 212 and detector 214, to prevent liquid that may be present on the substrate 10 or retaining ring 142 from dripping on and contaminating the optical components. In this case, the light beam 220 and reflected light beam 222 pass through a window 232 in a shield 230. The top surface of the shield 230 can be coplanar with the top surfaces of the platen(s) 120.

A purge gas 234 can be directed from an outlet 236 to flow across the bottom surface of the window 232. This can remove droplets from the bottom of the window 232 and prevent condensation and fogging of the window 232. The purge gas can be nitrogen or filtered air.

Alternatively or in addition, a purge gas can be directed onto the impingement spot 224. The purge gas can be humid gas, e.g., generated by passing deionized water and filtered air through an atomizer.

The output of the circuitry 216 can be a digital electronic signal that passes to the controller 190 for analysis. Similarly, the light source 212 can be turned on or off in response to control commands in digital electronic signals that pass from the controller 190 to the optical notch detector 210. Alternatively, the circuitry 216 could communicate with the controller 190 by a wireless signal.

For some processes, it is useful to have each substrate oriented to a consistent angular position before polishing commences. If the polishing operation has some inherent angular variation, e.g., due to a pattern of features on the substrate, then a consistent starting angular position can improve the ability to compensate for such variation, e.g., by application of varying pressure by the chambers inside the carrier head. In addition, a consistent starting angular position can improve the likelihood that the sensor 180 traces a consistent series of paths across the substrate on a wafer-to-wafer basis, thus making processing of the signal from the in-situ monitoring system more reliable.

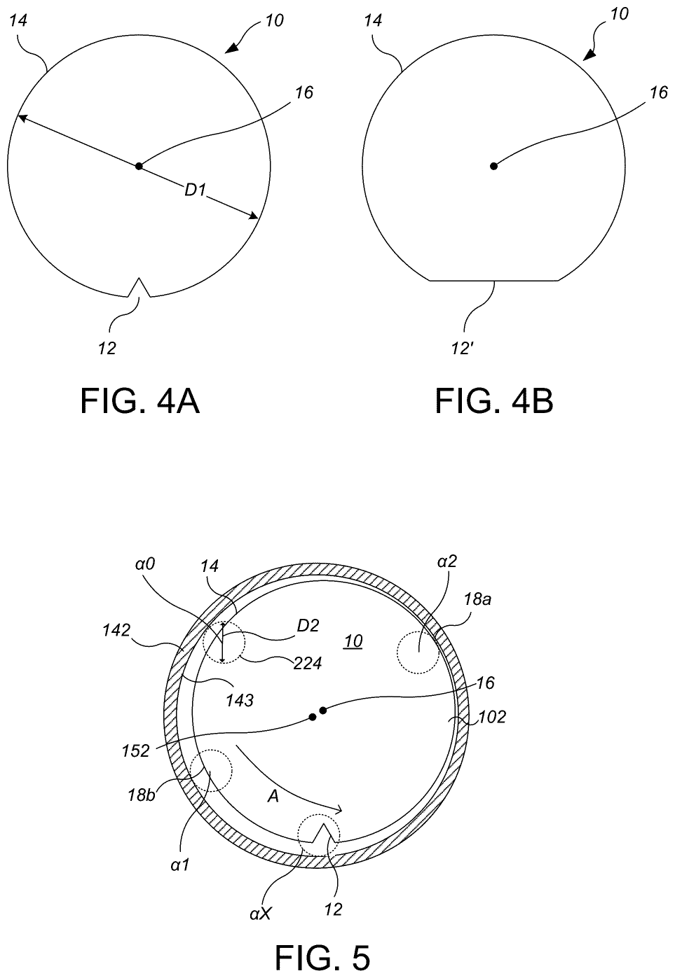

The substrate 10 to be polished generally includes a notch that allows the substrate 10 to be angularly oriented, for example, by a specific angle from the notch. The fiducial is generally defined by removal of a portion of the substrate. For example, as shown in FIGS. 4A-4B, a circular substrate 10 can have a notch 12 formed by the removal of a portion from the edge 14 of the substrate. The substrate 10 can have a diameter D1 of 200 mm or 300 mm. As shown in FIG. 4A, the notch 12 can be triangular in shape. Such a notch 12 can be relatively small, e.g., no more than 1 mm in depth from the substrate edge 14 and no more that 1 mm wide along the circumference (the size is significantly exaggerated in FIG. 4A for clarity), but a typical notch dimension is. 3.5 mm deep and 1.7 mm wide. Alternatively, as shown in FIG. 4B, the notch 12′ can be a “flat.”

Returning to FIG. 3, to operate, the carrier head 140 is positioned in the notch finding station 200 with the substrate 10 positioned above and spaced apart from the optical components of the at the optical notch detector 210. In particular the carrier head 140 is positioned such that the light beam 220 impinges the substrate 10 in an impingement spot 224 that contacts or overlaps the substrate edge 16. The carrier head 140 rotates so that the substrate 10 rotates, thus sweeping the light beam along the circumference of the substrate 10. Since the membrane 144 will have a different reflectivity than the substrate 10, the signal from the detector 214 should change when the notch 12 passes across the light beam 220.

Hypothetically, the scan of the light beam along the circumference of the substrate would result in a uniform signal, except for change where the notch is located. However, in practice, the situation is complicated. First, during the loading operation at the transfer station, the center of the substrate may not be precisely aligned with the axis of rotation of the carrier head. Second, during polishing, the substrate 10 can be driven laterally by frictional force from the polishing pad into contact with the retaining ring 142. As a result, referring to FIG. 5, the center point 16 of the substrate 10 can be offset from the axis of rotation 152 of the carrier head. This results the substrate edge 14 being closer to the inner diameter surface 143 of the retaining ring 142 in one region, e.g., at point 18a, and farther from the inner diameter surface 143 of the retaining ring 142 at an opposite region, e.g., at point 18b. This difference can be larger than the depth of the notch 12, e.g., 0.5-4 mm. Thus, for the light beam 220 to reliably catch the notch 12, the light beam needs to be wide enough that the notch 12 will fall within the impingement spot 224, regardless of the angular position of the substrate 10 relative to the carrier head 140. As such, the impingement spot 224 may need to have a radial width of about 1-10 mm, e.g., a diameter D2 of 5-10 mm for a circular impingement spot.

Ideally, the carrier head is positioned such that impingement spot 224 does not overlap the retaining ring 142 of the carrier head. However, the carrier head can be positioned such that impingement spot 224 overlaps the retaining ring 142. In this case, the retaining ring will contribute to the signal from the signal. However, since the retaining ring rotates about the axis of rotation 152, this contribution should be constant with the angular orientation of the carrier head.

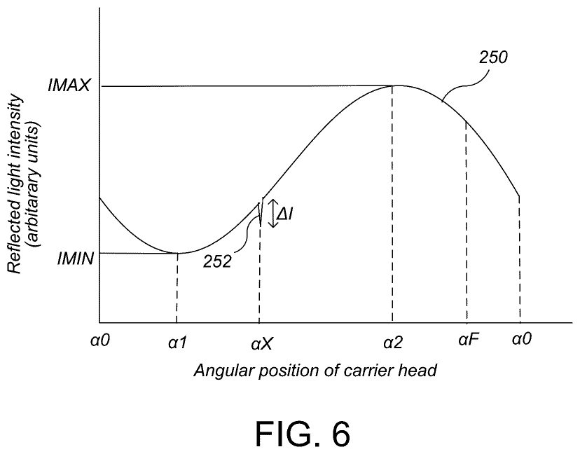

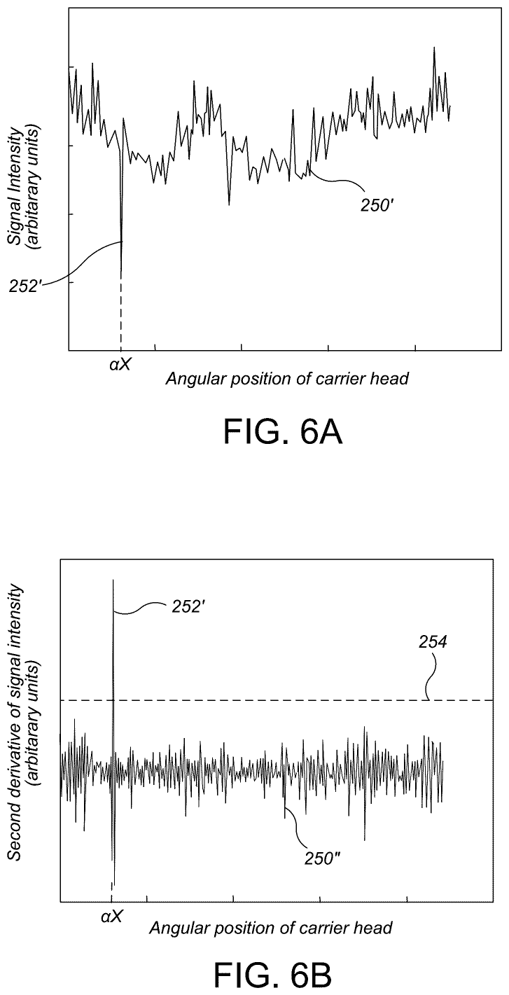

Referring now to FIGS. 5 and 6, as the carrier head rotates, the impingement spot 224 of the light beam will scan along the edge of the substrate 10 (shown by arrow A). As a result, the percentage of the impingement spot 224 that is reflected from the substrate 10 will vary with rotation of the carrier head.

In general, the membrane can be expected to have a lower reflectivity than the substrate 10. Thus, at angle α₁ where substrate 10 is farthest from the retaining ring 142, reflected light should be at a minimum I_{MIN}. In contrast, at angle α₂ where substrate 10 is closest to the retaining ring 142 and which should be offset from α₁ by 180°, the reflected light should be at a maximum I_{MAX}. At other positions between α₁ and α₂ the reflected light should vary between I_{MIN} and I_{MAX}, resulting in a signal from the sensor in the form of a sinusoidal wave 250 as shown in FIG. 6. In the example of FIGS. 5 and 6, the substrate starts at angle do with the reflected intensity first dropping and then increasing. But this is not required; the phase of the sinusoidal wave 250 relative to the starting position α₀ depends on the position of the closest point 18a along the circumference of the substrate 10.

When the carrier head is at an angular position ax where the impingement spot 224 overlaps the notch 12, there should be a drop 252 in the intensity of reflected light. As the notch 12 is relatively small compared to the impingement spot 224, the intensity difference ΔI of this drop can be smaller than the amplitude (I_{MAX}-I_{MIN}) of the sinusoidal wave 250.

However, a variety of techniques can still be used to detect this drop 252 in signal intensity, and thus the angular position ax of the notch 12. For example, a derivate, e.g., the first derivative, of the reflected light intensity signal can be monitored, and the controller can detect where the first derivative exceeds a threshold value. Where the first derivative exceeds the threshold value indicates the presence of the notch 12.

As another example, a sinusoidal function can be fit to the signal from the sensor, this sinusoidal function can be subtracted from the signal, and then the resulting differential can be analyzed to detect the drop 252. As yet another example, the signal can be subject to a high-pass filter.

Although FIG. 6 illustrates a smooth sinusoidal wave 250, in practice the signal may be subject to noise. For example, referring to FIG. 6A, measurement of the reflected light intensity signal from patterned substrate can generate a signal 250′ having signal variations resulting from the measurement spot passing over various metalized or non-metalized regions of the substrate, e.g., scribe lines versus dies. Although resulting from a real source, these variations can still be considered noise for the purpose of detection of the desired signal.

Other examples of distortions or noise include passage of the sensing across a portion of the retaining ring (or edge of the carrier head), the presence of water droplets in the case of dry measurements or the presence of air bubbles in the case of wet measurements, and electrical/sensor noise as well as mechanical and alignment noise.

In any event, as a result discriminating the drop 252′ resulting from the notch from noise can be particularly difficult for both a “wet” substrate, i.e., a substrate that has been polished and thus has water droplets, and for a patterned substrate. In some implementations, appropriate signal processing can compensate for these distortions or noise.

As an example, in order to address these problems, the signal can be subject to one or more filters. In particular, the signal can be subject to a low-pass filter to remove high-frequency noise, e.g., resulting from high density substrate pattern features or from scattering medium such as water droplets.

This filtered signal or unfiltered signal can then be normalized to the low-pass filtered raw signal.

The second derivative of the resulting (after the optional filtering and normalization) reflected light intensity signal can be monitored. In some implementations, the second derivative of the signal is compared to a threshold value.

FIG. 6B illustrates a graph of a second derivative signal 250″ generated as a second derivative of the intensity signal, e.g., signal 250′, as a function of the angular position of the carrier head for a patterned substrate. The controller can detect the angular position where the second derivative signal 250″ exceeds a threshold value 254; this location indicates the presence of the notch 12. Alternatively, the controller can detect the angular location of maximum peak or minimum valley of the second derivative signal 250″ from a full rotation of the CMP head. This is where the notch is located. Alternatively, a first derivative, or a third or higher order derivative of the resulting reflected light signal can be monitored using a similar technique.

In some implementations, the substrate can be scanned each of multiple full rotations. A notch can be detected for each rotation, and the angular positions, e.g., αX₁, αX₂, . . . αX_{N}, of the notch from the multiple scans 1, 2, . . . N, can be compared. Where the detected angular positions are all within a threshold amount, e.g., 2°, that angular position can be reported as the angular position of the notch. Where the detected angular positions are not within the threshold amount, e.g., the angular position which has the highest signal-to-noise ratio can be reported as the angular position of the notch.

The encoder for the drive shaft 156 outputs a signal indicating the angular position of some arbitrary (but fixed) point on the drive shaft. Once the angular position ax of the carrier head at which the notch is detected is known, the angular offset Aa of the notch 12 relative to the carrier head can be calculated. The fixed point might be at do, in which case Δα=αx, but more generically Δα=Δ_{F} −Δₓ.

With the angular offset Δα known, the carrier head can be rotated to bring the substrate 10 into a desired starting substrate angular orientation α_{D} before the polishing process, e.g., before lowing the substrate 10 into contact with the polishing pad. For example, the carrier head can be rotated to a starting carrier head angle αₛ, where αₛ=α_{D}−Δα.

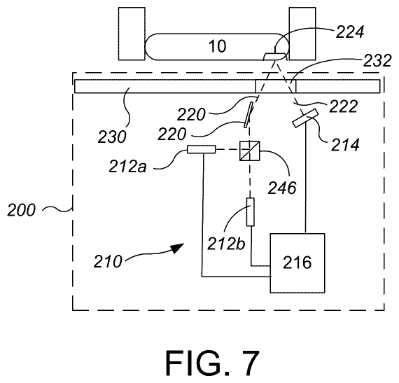

FIG. 7 shows an implementation of an optical notch detector 210 that includes two light sources 212a, 212b that generate light beams of different wavelengths, and a beam combiner 246 to combine the light beams into a single incident beam 220. For example, a first light source 212a can generate infrared light, whereas a second light source 212b can generate blue light.

For patterned substrates, there may be too much noise at certain wavelengths due to the pattern. However, by selecting an appropriate wavelength, noise from the pattern can be reduced. For a particular pattern, there should be a consistent wavelength that is superior. The controller 190 cause the optical notch detector 210 to scan the substrate 10 using each light source 212a, 212b sequentially, and then determine which light source provides a signal with the lower noise. In some implementations, light sources could be combined or selected individually to achieve better performance. The controller 190 can then use that light source or sources for monitoring of other substrates with the same pattern. That is, the controller 190 maintain a database that stores identifying information for different patterns, with each pattern having an associate light source(s) or wavelength.

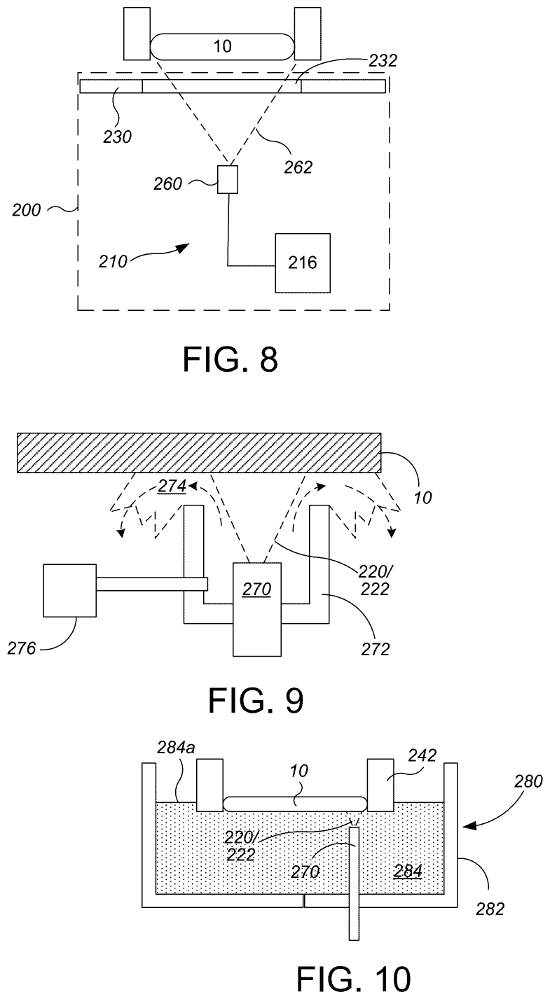

FIG. 8 shows an implementation of an optical notch detector 210 that includes a camera 260 with a field of view 262 of the substrate 10. For this implementation, the camera 260 can take an image or a sequence of images of substrate 10 when the substrate is at the notch detection station 20. In the illustrated implementation the view of view 262 spans the entire substrate 10. However, if the field of view is smaller than the substrate 10, then a combination of images may be used to construct a full substrate image; this may involve rotation and scanning of carrier head.

Image processing techniques can be used by the controller 190 on the image or sequence of images to determine the position of the notch and thus the angular orientation of the substrate 10.

In some implementations, image processing techniques can then be used by the controller 190 to determine the angular orientation of the pattern, e.g., the scribe lines and dies, of the substrate. This can provide an initial estimation of the angular orientation of the substrate, which can then be refined by detection of the notch position.

FIG. 9 shows an optical notch detector that directs the light beam 220 through a water column. In this implementation, a bifurcated optical fiber has two bifurcated ends that are connected to the light source and detector, respectively, and a trunk 270 that is situated inside a tube 272. A liquid 274, e.g., de-ionized water, can be pumped from a liquid source 276 into and through the tube 272. During the measurement, the substrate 10 can positioned over the trunk end of the optical fiber. The height of the substrate 10 relative to the top of the tube 272 and the flow rate of the liquid 274 is selected such that as the liquid 274 overflows the tube 272, the liquid 274 fills the space between the end 270 of the optical fiber and the substrate 10.

FIG. 10 shows an optical notch detector 210 in which at least the face of the substrate is lowered into a reservoir 280. The notch finding station 200 includes a housing or tub 292 which is holds a liquid 294. The substrate 10 and a portion of the carrier head, e.g., the bottom surface of the retaining ring 142, can be submerged in a liquid 284, e.g., de-ionized water, in the reservoir 280. The thickness of the substrate 10 is exaggerated in FIG. 10; in practice it is likely that the back surface of the substrate would be below the surface 284a of the liquid 284 of the reservoir 280. The trunk end 270 of the optical fiber can extend through the housing 292 into the reservoir 280 to be positioned near the edge of the substrate 10.

In either case of FIG. 9 or 10, in operation, light travels from the light source, travels through the liquid 274 or 284 to the surface of the substrate 10, is reflected from the surface of the substrate 10, enters the trunk end 270 of the optical fiber, and returns to the detector.

Although the description above has focused on a notch finding station that has an optical notch detector that uses reflected light intensity or imaging, a notch detector can use other types of sensors.

For example the notch detector can use confocal microscopy or laser displacement measurements. For example, a confocal microscope or a laser displacement sensor can be used to measure a height profile in a region that scans along the circumference of the substrate. The height difference between the bottom surface of the substrate and the bottom surface of the membrane or other backing surface that holds the substrate can be detected. This indicates the location of the notch feature.

As another example, the notch detector can use a capacitive sensing technique. In this example, the notch detector a capacitive sensor, and a capacitive signal resulting from scanning the sensor along the circumference of the substrate can be analyzed to detect the notch.

The above described polishing apparatus and methods can be applied in a variety of polishing systems. The platen may orbit rather than rotate. The polishing pad can be a circular (or some other shape) pad secured to the platen. The polishing layer can be a standard (for example, polyurethane with or without fillers) polishing material, a soft material, or a fixed-abrasive material.

The controller and other computing devices part of systems described herein can be implemented in digital electronic circuitry, or in computer software, firmware, or hardware. For example, the controller can include a processor to execute a computer program as stored in a computer program product, e.g., in a non-transitory machine-readable storage medium. Such a computer program (also known as a program, software, software application, or code) can be written in any form of programming language, including compiled or interpreted languages, and it can be deployed in any form, including as a standalone program or as a module, component, subroutine, or other unit suitable for use in a computing environment.

In context of the controller, “configured” indicates that the controller has the necessary hardware, firmware or software or combination to perform the desired function when in operation (as opposed to simply being programmable to perform the desire function).

A number of implementations have been described. Nevertheless, it will be understood that various modifications may be made without departing from the spirit and scope of the description. Accordingly, other implementations are within the scope of the following claims.

What is claimed is:

1. A notch finding apparatus, comprising:
a sensor to generate a signal that depends on an proportion of a sensing region of the sensor that is covered by a substrate; and
a controller is configured to
cause an actuator to position a carrier head relative to the substrate with the sensing region of the sensor at an edge of the substrate,
cause a motor to generate relative motion between the carrier head and the sensor such that the sensing region of the sensor scans along a circumference of the substrate, and
detect an angular position of a notch in the edge of the substrate based on an initial signal from the sensor, including generating a second or higher order derivative signal from the initial signal.

2. The apparatus of claim 1, wherein the controller is configured to apply a low-pass filter to the initial signal to generate a filtered signal, and to generate the second or higher order derivative signal from the filtered signal.

3. The apparatus of claim 2, wherein the controller is configured to normalized the filtered signal to generate a filtered and normalized signal, and to generate the second or higher order derivative signal from the normalized and filtered signal.

4. The apparatus of claim 1, wherein the controller is configured to generate a second derivative signal from the initial signal.

5. The apparatus of claim 1, wherein the controller is configured to compare the second or higher order derivative signal to a threshold value and determine an angular position where the second or higher order derivative signal is outside the threshold.

6. The apparatus of claim 1, wherein the controller is configured to determine an angular position at which the second or higher order derivative signal has a maximum peak or a minimum valley.

7. The apparatus of claim 1, wherein the controller is configured to cause the cause the motor to generate relative motion between the carrier head and the sensor such that the sensing region of the sensor scans along the circumference a single time to obtain the initial signal.

8. The apparatus of claim 1, wherein the controller is configured to cause the cause the motor to generate relative motion between the carrier head and the sensor such that the sensing region of the sensor makes multiple scans along the circumference to obtain the initial signal.

9. The apparatus of claim 1, wherein the controller is configured to detect an angular position of the notch from each respective scan of the multiple scans to generate a plurality of possible angular positions with each possible angular position of the plurality of possible angular positions corresponding to a respective scan.

10. The apparatus of claim 9, wherein the controller is configured to compare the plurality of possible angular positions to each other.

11. The apparatus of claim 10, wherein the controller is configured to determine whether the plurality of possible angular positions are within a threshold difference.

12. The apparatus of claim 11, wherein the controller is configured to set a determined angular position of the notch based on at least one of the possible angular positions in response to determining that the plurality of possible angular positions are within the threshold difference.

13. The apparatus of claim 12, wherein the controller is configured to, in response to determining that the plurality of possible angular positions are not within the threshold difference, determine which possible angular position from the plurality of possible angular positions corresponds to a peak in the second or higher order derivative signal having a highest signal-to-noise ratio out of the multiple scans.

14. The apparatus of claim 9, wherein the controller is configured to determine which possible angular position from the plurality of possible angular positions corresponds to a peak in the second or higher order derivative signal having a highest signal-to-noise ratio out of the multiple scans.

15. The apparatus of claim 1, wherein the sensor comprises an optical sensor including a light source to generate a light beam that impinges a surface of the substrate and a detector to detect reflected light and generate a signal indicating an intensity of the reflected light.

16. A polishing apparatus, comprising:
a plurality of stations including a first station that is a polishing station or a transfer station and a second station that is a polishing station;
a carrier head to hold a substrate, the carrier head movable by an actuator along a path from the first station to the second station;
a motor to rotate the carrier head about an axis of rotation; and
a notch finding apparatus according to claim 1.

17. The polishing apparatus of claim 16, comprising a notch finding station positioned on the path between the first station and the second station, wherein the sensor is located in the notch finding station.

18. A computer program product, comprising a non-transitory storage medium encoded with instructions to cause one or more computers to:
cause an actuator to position a carrier head relative to a substrate with a sensing region of a sensor at an edge of the substrate;
cause a motor to generate relative motion between the carrier head and the sensor such that the sensing region of the sensor scans along a circumference of the substrate; and
detect an angular position of a notch in the edge of the substrate based on an initial signal from the sensor, including generating a second or higher order derivative signal from the initial signal.

19. The computer program product of claim 18, comprising instructions to apply a low-pass filter to the initial signal to generate a filtered signal, and to generate the second or higher order derivative signal from the filtered signal.

20. The computer program product of claim 19, comprising instructions to normalized the filtered signal to generate a filtered and normalized signal, and to generate the second or higher order derivative signal from the normalized and filtered signal.

21. A polishing apparatus, comprising:
a plurality of stations including a first station that is a polishing station or a transfer station and a second station that is a polishing station;
a carrier head to hold a substrate, the carrier head movable by an actuator along a path from the first station to the second station;
a motor to rotate the carrier head about an axis of rotation;
a sensor to generate a signal that depends on an proportion of a sensing region of the sensor that is covered by a substrate; and
a controller is configured to
cause the actuator to position a carrier head relative to the substrate with the sensing region of the sensor at an edge of the substrate,
cause the motor to generate relative motion between the carrier head and the sensor such that the sensing region of the sensor makes multiple scans along a circumference to obtain an initial signal,
detect an angular position of a notch on the substrate from each respective scan of the multiple scans to generate a plurality of possible angular positions with each possible angular position of the plurality of possible angular positions corresponding to a respective scan, and
select an angular position from the plurality of angular positions.

22. The apparatus of claim 21, wherein the controller is configured to determine whether the plurality of possible angular positions are within a threshold difference.

23. The apparatus of claim 22, wherein the controller is configured to set a determined angular position of the notch based on at least one of the possible angular positions in response to determining that the plurality of possible angular positions are within the threshold difference.

24. The apparatus of claim 23, wherein the controller is configured to, in response to determining that the plurality of possible angular positions are not within the threshold difference, determine which possible angular position from the plurality of possible angular positions corresponds to a peak in the second or higher order derivative signal having a highest signal-to-noise ratio out of the multiple scans.

25. The apparatus of claim 24, wherein the controller is configured to determine which possible angular position from the plurality of possible angular positions corresponds to a peak in the second or higher order derivative signal having a highest signal-to-noise ratio out of the multiple scans.

26. The apparatus of claim 21, wherein the controller is configured to determine which possible angular position from the plurality of possible angular positions corresponds to a peak in the second or higher order derivative signal having a highest signal-to-noise ratio out of the multiple scans.

27. The apparatus of claim 21, wherein the sensor comprises an optical sensor including a light source to generate a light beam that impinges a surface of the substrate and a detector to detect reflected light and generate a signal indicating an intensity of the reflected light.
